(19) United States
(12) Patent Application Publication
(10) Pub. No.: US 2001/0048037 A1
(43) Pub. Date: Dec. 6, 2001

(54) Chemical infeed system for a sprinlker or irrigation system

(76) Inventors: Michael J. Bell, Worden, IL (US); James W. McClure, Cape Coral, FL (US)

Correspondence Address: HAVERSTOCK, GARRETT & ROBERTS, 611 OLIVE STREET, SUITE 1610, ST. LOUIS, MO, 63101, US

(21) Appl. No.: 09/798,737

(22) Filed: Mar. 2, 2001

Related U.S. Application Data
(60) Provisional application No. 60/187,245, filed on Mar. 3, 2000.

(51) Int. Cl. B05B 7/26; B05B 12/02

(52) U.S. Cl. 239/70; 239/310

(57) ABSTRACT

A chemical infeed system for a sprinkler or irrigation system including a water carrying element or supply line such as a pipe or tube for the flow of water to one or more sprinkler heads or other outlets or openings, the infeed system including at least one receptacle or container for receiving and holding a quantity of a desired chemical; a pump having an inlet or suction side for pumping or drawing the chemical from the receptacle and a discharge or outlet side connected in liquid communication with the water carrying element or supply line for pumping the chemical into the water flow therethrough. The pump of the present chemical infeed system can be powered by conventional line current, such as 110 volt household current, and can be actuated by a relay or other device which connects the pump to a power source when a power signal is received from a controller of the sprinkler or irrigation system. The power signal may be the same voltage or a different voltage than the power source for the pump. Alternatively, the pump can be powered directly by the controller.

### TECHNICAL FIELD

This invention relates generally to automatic sprinkler and irrigation systems for lawns, golf courses and agriculture fields, and more particularly, to a system for infeeding chemicals such as, but not limited to, fertilizers, and/or insecticides, and/or pesticides, and/or weed killers into water flowing through the sprinkler or irrigation system for expulsion with the water onto the lawn or other land to provide beneficial effect.

### BACKGROUND ART

Currently, chemicals such as fertilizer, insecticide, pesticide, and weed killer are typically spread in granular form using broadcast spreaders, drop spreaders, and the like. Chemicals in liquidous form are typically spread using a variety of well known hand spraying devices. Spraying devices which mount atop a sprinkler head for distributing chemicals are also known.

However, shortcomings of the known granular and liquid chemical spreading devices include difficulty in achieving uniform, even chemical coverage and hazards attendant to handling the chemicals. Substantial manual effort is also required. If professional services are utilized, application cost is high. Further, for lawns, golf courses, agricultural lands, and the like wherein a sprinkler or irrigation system is utilized, the rate of chemical delivery using the known devices may not correspond to the water delivery rate, resulting in over or under application of the chemicals in some areas. For systems wherein chemicals can be distributed through individual sprinkler heads, a shortcoming is the requirement of filling the chemical receptacles of the individual sprinkler heads.

Accordingly, the present invention is directed to overcoming one or more of the problems as set forth above.

### DISCLOSURE OF THE INVENTION

In one aspect of the invention, a chemical infeed system for a sprinkler or irrigation system including a water carrying line or supply line such as a pipe or tube for the flow of water to one or more sprinkler heads or other outlets or openings, is disclosed. The present chemical infeed system includes at least one receptacle or container for receiving and holding a quantity of a desired chemical; a pump having an inlet or suction side for pumping or drawing the chemical from the receptacle and a discharge or outlet side connected in liquid communication with the water carrying element or supply line for pumping the chemical into the water flow therethrough. The pump of the present chemical infeed system can be powered by conventional line current, such as 110 volt household current, and can be actuated by a relay or other device which connects the pump to a power source when a power signal is received from a controller of the sprinkler or irrigation system. The power signal may be the same voltage or a different voltage than the power source for the pump. Alternatively, the pump can be powered directly by the controller. For instance, if the controller generates a lower voltage power signal, for instance, a 24 volt signal, for actuating solenoid or other valves controlling water flow in the sprinkler or irrigation system, the pump could be powerable using the same voltage and directly connected to the controller output such that when the 24 volt or other power signal is outputted, the pump is actuated.

As optional features of the present invention, a flow regulator can be provided for regulating the rate of chemical inflow into the sprinkler or irrigation system. A backflow preventor can be provided to prevent water from the water supply line from flowing into the infeed system, and/or one can be provided in the water supply line to prevent the chemical or chemicals of the infeed system from flowing into the water supply. Additionally, the inlet side of the pump can be connected in fluid communication with additional chemical receptacles or containers for drawing chemicals therefrom, valves being provided to enable manually or automatically selecting a receptacle or container, or multiple receptacles or containers, for feeding chemicals into the water flow at any given time. In this instance, a programmable logic controller (PLC) or other controller can be utilized for automatic operation. Further, the controller can be operable to control a valve or valves of the sprinkler or irrigation system which control the flow of water to the at least one nozzle, outlet or other opening, respectively, the controller being operable to initiate the operating of the pump to cause the liquid chemical to enter the water carrying element for a period of time while the valve or valves are closed to better mix the liquid chemical with the water in the water carrying element.

### BRIEF DESCRIPTION OF THE DRAWINGS

FIG. 1 is a simplified schematic representation of one chemical infeed system according to the present invention;

FIG. 2 is a simplified schematic representation of another chemical infeed system of the present invention; and

FIG. 3 is a simplified schematic representation of still another chemical infeed system of the present invention.

### DETAILED DESCRIPTION

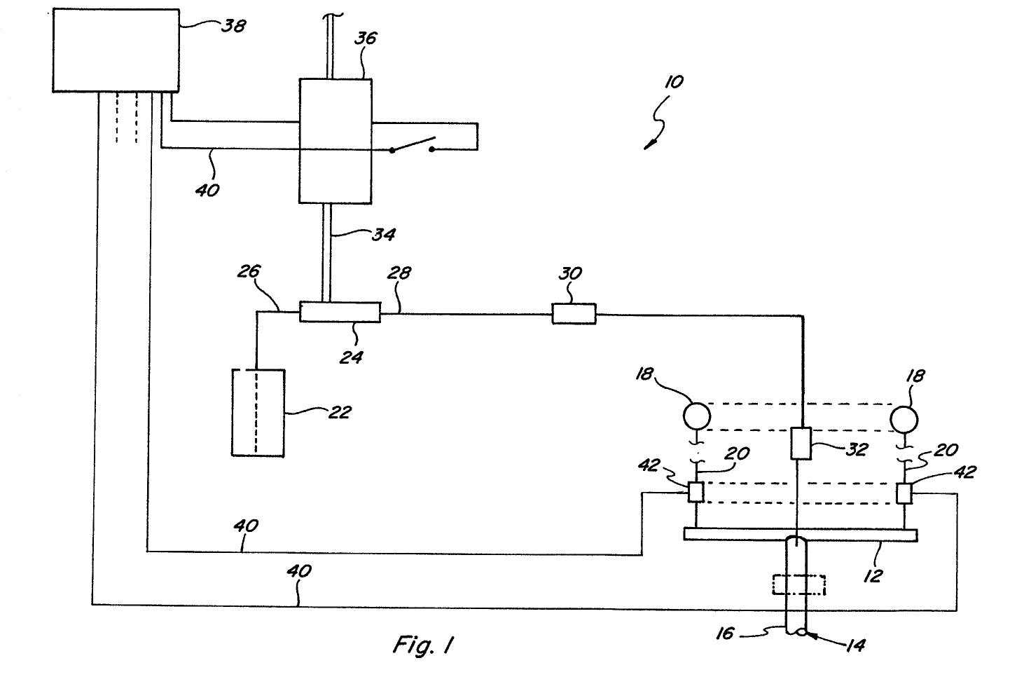

Referring now to FIG. 1, a chemical infeed system 10 constructed and operable according to the teachings of the present invention is shown connected to a manifold 12 which is one water carrying element of a typical prior art lawn sprinkler or irrigation system 14. The sprinkler or irrigation system 14 includes a main supply line 16 connected in liquid communication with a source of water such as a lake, pond, well or water system in the conventional manner (not shown). The main supply line 16 provides a flow of water to the manifold 12, which in turn, is connected to one or more outlets or openings such as sprinkler heads 18, via water distribution lines 20 in the well known manner.

The present infeed system 10 is shown including one chemical container 22 for receiving and holding a quantity of a liquid chemical desired to be applied to the area to be sprinkled or irrigated, which chemical can include, but is not limited to, one or more fertilizers and/or pesticides and/or insecticides and/or weed killers commercially available, for instance in concentrated liquid form.

The present system 10 includes a pump 24 having an inlet or suction line 26 positioned for drawing or sucking the chemical from the chemical container 22 and an outlet or discharge line 28 connected to the manifold 12 or another water carrying element of the sprinkler or irrigation system 14

Here, it should be recognized and understood that the present system 10 can be connected to the manifold 12, the main supply line 16 or any other water carrying element of the sprinkler or irrigation system 14 without departing from the scope of the present invention.

A conventional flow regulator 30 and a conventional backflow preventor 32 are shown in the discharge line 28 for regulating flow to the sprinkler or irrigation system 14 and preventing backflow into the present infeed system 10, respectively. The pump 24 of the present system 10 is shown connected to a 110 volt power line 34 which can be connected to a conventional electrical power grid (not shown) in a well known manner. Disposed between the pump 24 and the power grid is a pump relay starter 36 which is connected to a controller 38 of the sprinkler or irrigation system 14 via a conductive path 40 for receiving an output signal therefrom at selected times when the sprinkler or irrigation system 14 is actuated.

Essentially, the controller 38 of the sprinkler or irrigation system 14 is connected to the electrical power grid or another source of such as a battery or photovoltaic source and includes conventional circuitry for generating and outputting, over conductive paths 40, signals for opening and closing valves 42 disposed between the manifold 12 and each of the sprinkler heads 18 to control the discharge of water therefrom. According to the invention, the pump relay starter 36 is operated by a similar signal to allow current flow from the power grid to the pump 24 such that the chemical contained within the chemical container 22 is drawn therefrom and pumped into the water flow through the sprinkler or irrigation system 14 so as to be mixed with the water and be discharged onto a lawn or other area to be sprinkled or irrigated. Then, when the output signal from the controller 38 to relay starter 36 commands, current flow to the pump 24 is terminated thereby halting its operation.

Here, it should be understood that many conventional controller units of commercially available sprinkler and irrigation systems generate a 24 volt or other low voltage signal which is less than conventional 110 or 220 volt household current. Thus, as an alternative to the 110 volt pump 24 shown, a pump operating at a voltage corresponding to the output voltage of the controller unit of the sprinkler or irrigation system could be used, such that the pump could be directly connected to the output of the controller unit so as to be actuated directly thereby. Further, it is contemplated that a pressure, flow or other sensor operable for sensing flow through manifold 12, main supply line 16 or other water carrying element or conduit of the sprinkler or irrigation system could be utilized for actuating the pump. Likewise, a bypass can be provided in association with the pump, as desired. The pump is an important element of the present invention, as it is required to infeed the chemical into the water flow at an equal or higher pressure than the water pressure at the infeed location. Further, at the point of infeed of the chemical into the water flow, it is contemplated that various nozzles, diffusers or other devices could be used for better mixing the chemical with the water.

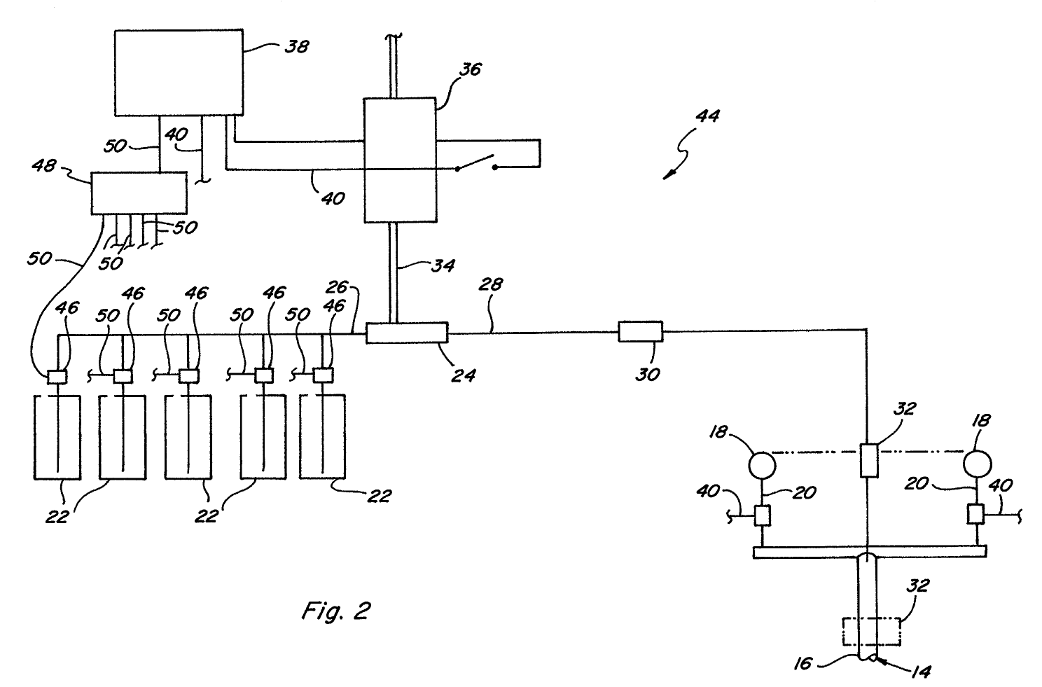

Referring to FIG. 2, a chemical infeed system 44 similar to system 10 of FIG. 1 and explained above is shown in association with a conventional sprinkler or irrigation system 14, like parts of system 44 and system 10 being identified by like numerals. System 44 of FIG. 2 differs from system 10 of FIG. 1 in the provision of additional chemical containers 22 for holding additional or different liquid chemicals. Each chemical container 22 is shown connected to the inlet or suction line 26 of the pump 24 and can be selected by opening a valve 46, which can be conventional solenoid valve or the like, disposed between that container 22 and the pump 24. For instance, the various containers 22 could contain different concentrations or compositions of fertilizers, pesticides, insecticides, weed killers and the like. The valves 46 controlling communication of the different containers with the pump can be selectably opened for application of the desired chemical as and when required. The valves 46 can be manually operated valves, or automatically operated valves such as, for instance, commonly available solenoid controlled valves, controllable by any well known conventional valve actuator device 48, for instance, one or more well known processor controlled PLCs or the like currently available. Device 48 can be connected to the valves 46 for supplying operating signals and energy thereto in any suitable manner, for instance by conductive paths 50. Valve actuator device 48 can also be connected to controller 38 via a conductive path 50 for receiving a control signal and energy therefrom for operating valves 46.

Here, it should be noted that the pump relay starter 36 can be eliminated if the pump 24 is operable at the output voltage of the controller 38 of the sprinkler or irrigation system 14. Note also that a backflow preventor 32 is shown in the main supply line 16 of the sprinkler or irrigation system 14 for preventing accidental pumping of chemical into the main water supply if pressure differential conditions allowing such are present.

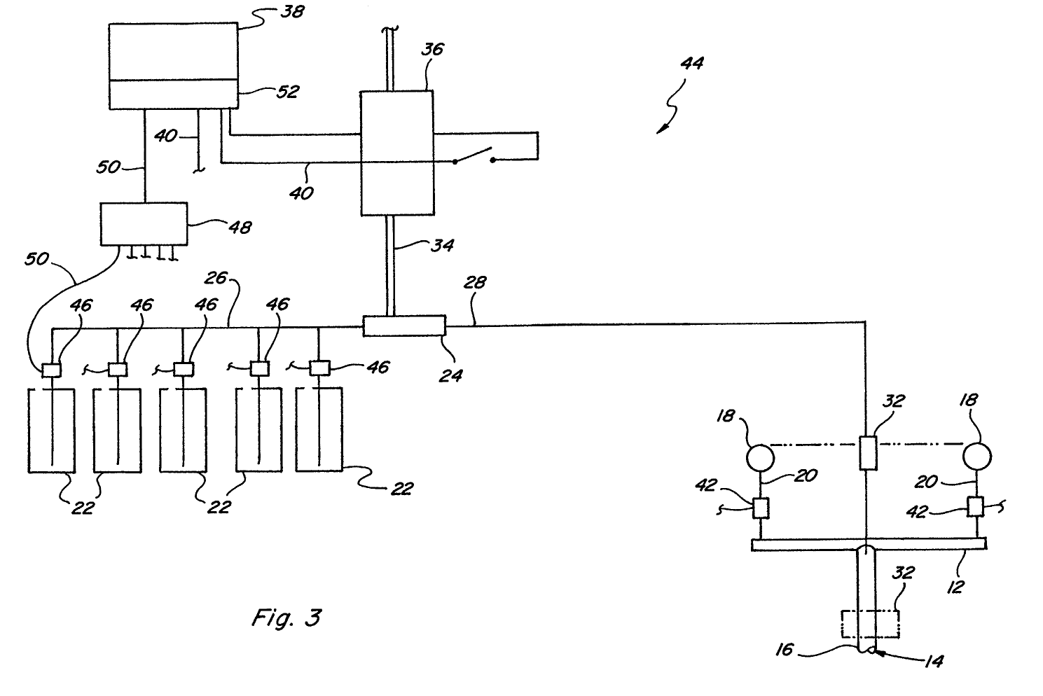

Referring to FIG. 3, the chemical infeed systems of the present invention, as illustrated by system 44 can include a timer 52 operable in association with pump 24 and valves 42 for regulating the time period of operation of the pump 24 in conjunction with valves 42, for improving the mixing of the infed chemicals with the water flow of the system 14. To illustrate, timer 52 can be actuated in conjunction with the opening of one or more of valves 46 to initiate operation of pump 24 for a selected period of time, for instance 15 to 30 seconds, prior to opening of any of the valves 42 controlling the flow of water to the sprinkler heads 18. This causes discharge line 28 to be primed with the selected chemical, so as to reduce air pockets in line 28 and system 14, and better mix the liquid chemical with the water in the manifold 12 and other water carrying elements of system 14. Pump 24 can be allowed to operate only until a selected valve or valve 42 is opened, or can be allowed to continue operation thereafter to achieve a desired distribution of the selected chemical. Additionally, or alternatively, timer 52 can be used to stop or reduce the infeeding of the chemical by stopping operation of pump 24 prior to stoppage of water flow to one or more sprinkler heads 18 such that a desired amount of water is allowed to flow through the sprinkler or irrigation system 14 to reduce the amount of chemical remaining and to clean the valves 42, sprinkler heads 18, etc. Here, it has been observed that, due to the presence of a backflow preventor 32 in discharge line 28, when pump 24 is stopped before water flow through valves 42 is stopped, the chemical in line 28 can be siphoned therefrom, leaving pockets that can be displaced or filled with chemical to prime discharge line 28 for the next sprinkling or irrigating cycle. An advantage here is that if the siphoning effect is used to advantage, it may be possible to utilize a pump 24 which operates at a pressure lower than the operating pressure of sprinkler or irrigation system 14. It is also possible to eliminate flow regulator 30 from the infeed system, as shown.

From the disclosure herein, it should be apparent that using the present systems chemicals can be evenly applied to an area such as a lawn, golf course, garden, shrubbery bed, agricultural field, and the like as a sprinkling or watering operation is conducted. Using the present systems 10, 44, an amount of the chemical is applied which corresponds to the amount of water applied in a desirable manner. The present systems 10, 44 can be added or retrofitted to an existing sprinkler or irrigation system, or can be installed with a new sprinkler or irrigation system. The present systems are simple to manufacture, make and install, and are inexpensive and overcome many of the shortcomings and disadvantages of known systems described hereinabove. The present systems also provide versatility to allow chemical application at times when an operator is not present and when others to whom the chemicals may present a hazard are not present. Additionally, the chemicals can be applied using the present systems with minimal handling.

1. A liquid chemical infeed system for a sprinkler or irrigation system having a water carrying element for carrying a flow of water at a first pressure from a water source to at least one opening through which the water is discharged from the sprinkler or irrigation system, the infeed system comprising;
a pump having an inlet connected to a container for holding a quantity of the liquid chemical for drawing the liquid chemical therefrom, and an outlet for discharging the liquid chemical, the pump being operable of discharging the liquid chemical at a second pressure which is at least equal to the first pressure;
a discharge line having a first end connected to the outlet of the pump for receiving the liquid chemical and a second end for connecting to the water carrying element for discharging the liquid chemical into the flow of water; and
a controller including circuitry connected to the pump for generating an output signal for operating the pump for controlling the discharging of the liquid chemical in a predetermined timed relation to the flow of water so as to cause the liquid chemical to mix to a desired extent with the water and be discharged from the sprinkler or irrigation system mixed with the water.

2. The system of claim 1, wherein the inlet of the pump is connected to at least one additional container for holding a quantity of another liquid chemical and valves are disposed between each of the containers and the pump, respectively, for allowing the pump to selectably draw the liquid chemicals from the containers.

3. The system of claim 2, further comprising a controller connected to each of the valves and including circuitry for automatically opening and closing the valves for allowing the pump to selectably draw the liquid chemicals from the containers.

4. The system of claim 1, further comprising a flow regulator disposed in the discharge line for regulating flow of the liquid chemical therethrough.

5. The system of claim 1, further comprising a backflow preventor disposed in the discharge line to prevent the water in the water carrying element from flowing through the discharge line to the pump.

6. The system of claim 5, wherein the controller is operable to control a valve of the sprinkler or irrigation system which controls the flow of water to the at least one opening, the controller being operable to initiate the operating of the pump to cause the liquid chemical to enter the water carrying element for a period of time while said valve is closed to prime the discharge line with the liquid chemical.
